(19) United States
(12) Patent Application Publication
(10) Pub. No.: US 2003/0147523 A1
(43) Pub. Date: Aug. 7, 2003

(54) HPNA network bridge

(76) Inventors: Paul T. Watson, Alpharetta, GA (US); Randy S. Zimler, Gainesville, GA (US); John A. Hicks, Roswell, GA (US)

Correspondence Address: Woodcock Washburn LLP, One Liberty Place -46th Floor, Philadelphia, PA, 19103, US

(21) Appl. No.: 10/068,673

(22) Filed: Feb. 6, 2002

(51) Int. Cl. H04M 1/00; H04M 3/00

(52) U.S. Cl. 379/344; 379/387.01

(57) ABSTRACT

An HPNA bridge comprises a bi-directional filter for blocking non-HPNA signals and splitter for distributing the filtered signal to at least one additional telephone wire pair. The filter may be a high pass filter allowing signals with a frequency above a threshold value, including HPNA signals, to pass. Alternatively, the filter may be a band pass filter allowing only signals within the HPNA frequency range to pass.

### FIELD OF THE INVENTION

The present invention relates generally to broadband telecommunications systems, and more particularly, to systems and methods for home networking.

### BACKGROUND

There has been a movement in recent years to bring broadband data connections to the home. For example, digital subscriber lines (DSL) and cable modems have seen widespread deployment in many areas. Broadband connections provide high speed Internet connectivity to the home and have been very popular amongst a large segment of consumers. Indeed, the availability of high-speed data connectivity to the home has spurred an emerging industry sometimes referred to as “home networking.”

Generally, home networking refers to technologies that allow for the interconnection of computing and electronics devices in the home. The demand for such interconnectivity is due, at least in part, to the desire to interconnect multiple computers and share a single broadband connection, as well as other network resources such as printers, scanners, etc. Several different technologies have been proposed for implementing home networks. These include, for example, conventional Ethernet networks, wireless Bluetooth networks, and power line networks.

One home networking technology that has gained recognition is that designed by the Home Phoneline Network Alliance (HPNA). Generally, the HPNA specification employs existing twisted pair telephone wires in the home to connect computing devices at data rates approaching 10 Mbits per second. Future HPNA specifications include data rates that reach and eventually exceed 30 Mbps. In an HPNA network, connecting computers to the network and making available all of the network resources is as simple as plugging a connector into a standard RJ-11 phone jack. HPNA uses frequency division multiplexing (FDM) to transmit home network data traffic on the same twisted wire pairs that simultaneously are used to transmit non-HPNA signals such as, for example, telephone and DSL signals. HPNA transmits in the 10 MHz to 15 Mhz frequency range, as compared to telephone traffic, which typically transmits in the 15 HZ to 4 KHz range, and DSL, which typically transmits in the 25 KHz to 1.1 MHz range.

Generally, existing HPNA networks employ a single telephone wire pair as the network transport medium. Applicants have noted, however, that many homes are serviced by more than one twisted wire pair. For example, many homes have several phone lines, each of which requires a separate telephone wire pair. Optimally, in an HPNA network, it should be possible to plug into any phone jack in the house and have connectivity to the HPNA enabled network. However, in existing systems, only devices connected to the same telephone wire pair can communicate using HPNA. Therefore, in a house having more than one telephone line, connecting a device to a phone jack, which may correspond to any one of the plurality of phone lines, does not insure that the device will be available, or have access to all of the other devices connected to phone jacks in the house.

Thus, there is a need in the art for an apparatus to bridge HPNA connectivity between a plurality of twisted wire pairs in a house.

### SUMMARY OF THE INVENTION

Accordingly, the present invention is directed HPNA bridge for providing HPNA connectivity across multiple POTS telephone lines. Generally, a bridge in accordance with an illustrative embodiment of the invention comprises a filter for blocking non-HPNA frequency signals carried on a POTS wire pair, and a splitter for producing the filtered signal on at least one additional POTS wire pair. HPNA enabled devices that are connected to a POTS telephone wire pair that is connected to an input side of the HPNA bridge, can communicate with HPNA devices connected to a second POTS telephone wire pair connected to the output side of the bridge.

The filter may be a bi-directional high pass filter, which removes low frequency signals such as those associated with telephony while allowing higher frequency signals such as HPNA and xDSL signals to pass through. Alternatively, the filter may be a bi-directional band pass filter, which allows only frequencies associated with HPNA to pass through while blocking frequencies associated with all other communications such as telephony and xDSL.

Additional aspects of the invention are described in detail below.

### BRIEF DESCRIPTION OF THE DRAWINGS

Other features of the invention will be further apparent from the following detailed description of presently preferred exemplary embodiments of the invention taken in conjunction with the accompanying drawings, of which:

FIG. 1 is a diagram of a home network;

FIG. 2 is a diagram depicting power as a function of frequency for various home communication technologies;

FIG. 3A is a diagram of an illustrative embodiment of an HPNA bridge in accordance with the invention bridging HPNA signal across telephone line pairs;

FIG. 3B is a diagram of an illustrative embodiment of an HPNA bridge in accordance with the invention bridging HPNA signal across telephone line pairs; and

FIG. 3C is a diagram of another illustrative embodiment of an HPNA bridge in accordance with the invention bridging HPNA signal across telephone line pairs.

### DETAILED DESCRIPTION OF THE INVENTION

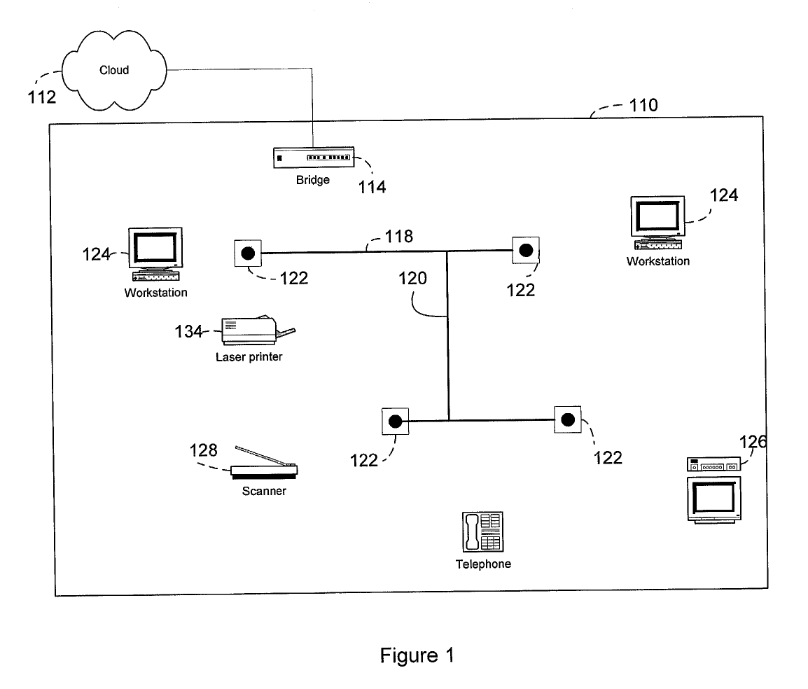

An HPNA bridge in accordance with an illustrative embodiment of the invention will be described below with reference to FIGS. 1-3. It will be appreciated by those of ordinary skill in the art that the description given herein with respect to those figures is for exemplary purposes only and is not intended in any way to limit the scope of the invention. All questions regarding the scope of the invention may be resolved by referring to the appended claims.

Generally, an HPNA bridge in accordance with the invention provides passive bridging of an HPNA signal to a plurality of POTS telephone wire pairs. Accordingly, in a house having multiple telephone lines, and therefore multiple telephone wire pairs, an HPNA bridge in accordance with the invention may be used to provide access to HPNA enabled devices throughout the home, regardless of the telephone wire pair to which the devices are connected.

FIG. 1 is a diagram depicting home networking using HPNA interconnectivity. As shown, home 110 has an external connection to public networks 112 such as, for example, the Internet. This connectivity is provided through broadband device 114, which may be, for example, a DSL modem or cable modem. Broadband device 114 has an HPNA gateway therein for providing access to devices connected to home telephone line network 118. Home telephone line network 118 comprises standard POTS telephone wire pairs 120 and a plurality of RJ11 phone jacks 122. Devices such as, for example, computers 124, set top boxes 126, scanners 128, and printers 134 can be fitted with an HPNA adapter to communicate over telephone line network 118. HPNA allows for communication between these devices and sharing of the devices over network 118. For example, computers 124 and set top box 126 can access and share the single broadband connection provided by device 114. Similarly, printer 134 and scanner 128 can be accessed by computers 124 over network 118.

Thus, the HPNA specification provides for creating an in-home network using existing telephone wires. However, existing HPNA systems provide access over a single telephone wire pair, i.e. only devices connected to the same telephone wire pair can communicate with each other. For example, in the diagram of FIG. 1, it is presumed that network 118 comprises a single telephone wire pair throughout so that all of the devices are connected to the same telephone wire pair. In homes that have multiple telephone lines, and therefore multiple telephone wire pairs, it cannot be presumed that connecting a device to a telephone jack necessarily provides connectivity to the same telephone wire pair as other devices. Indeed, in homes with multiple telephone lines it is likely that connecting a device to a jack will not result in connecting to the same telephone wire pair as all other devices. Applicants have sought to address this limitation in the art with an HPNA bridge.

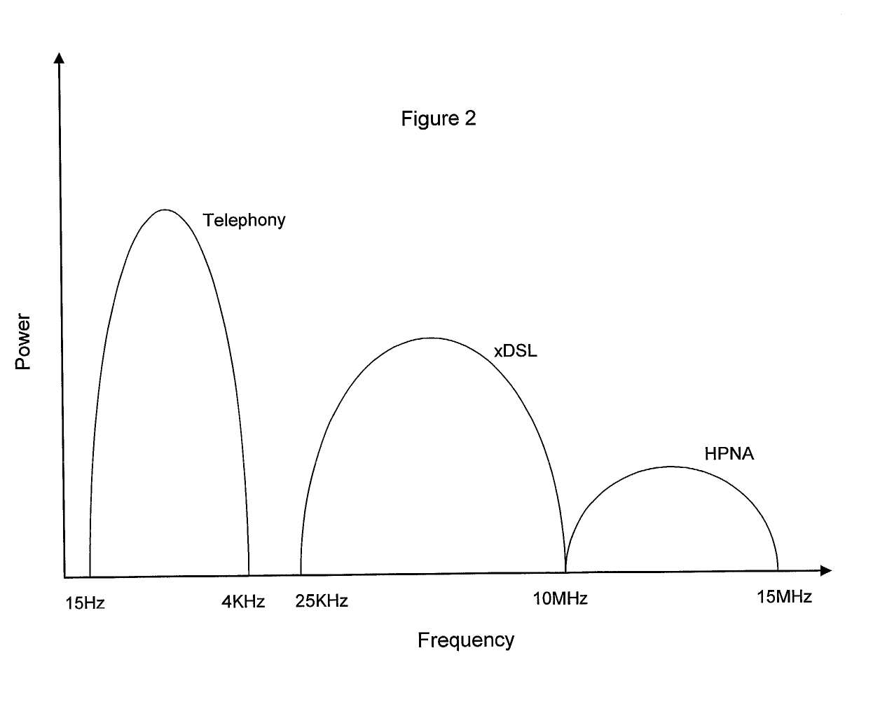

FIG. 2 provides a diagram depicting power as a function of frequency for various home communication technologies. As shown, typical telephony services such as, for example, telephone voice communications, operate in the frequency range of about 15 Hz to 4 KHz. XDSL operates at higher frequencies such as, for example, between about 25 KHz to 10 MHz. The HPNA specification defines that HPNA devices communicate at still higher frequencies such as, for example, from about 10 MHz to 15 MHz. Thus, standard telephony, xDSL, and HPNA operate in different frequency ranges. It is possible, and indeed likely, that telephony, xDSL, and HPNA signals be transmitted simultaneously on a single telephone wire pair. Applicants have recognized that in connection with bridging signals from one telephone wire pair to another, it may be necessary to filter non-HPNA signals that are not meant to be bridged to a second line. For example, while it may be desired to provide a bridge for HPNA signals between two telephone wire pairs, it is necessary to block telephony signals so that they too are not bridge to a second telephone wire pair.

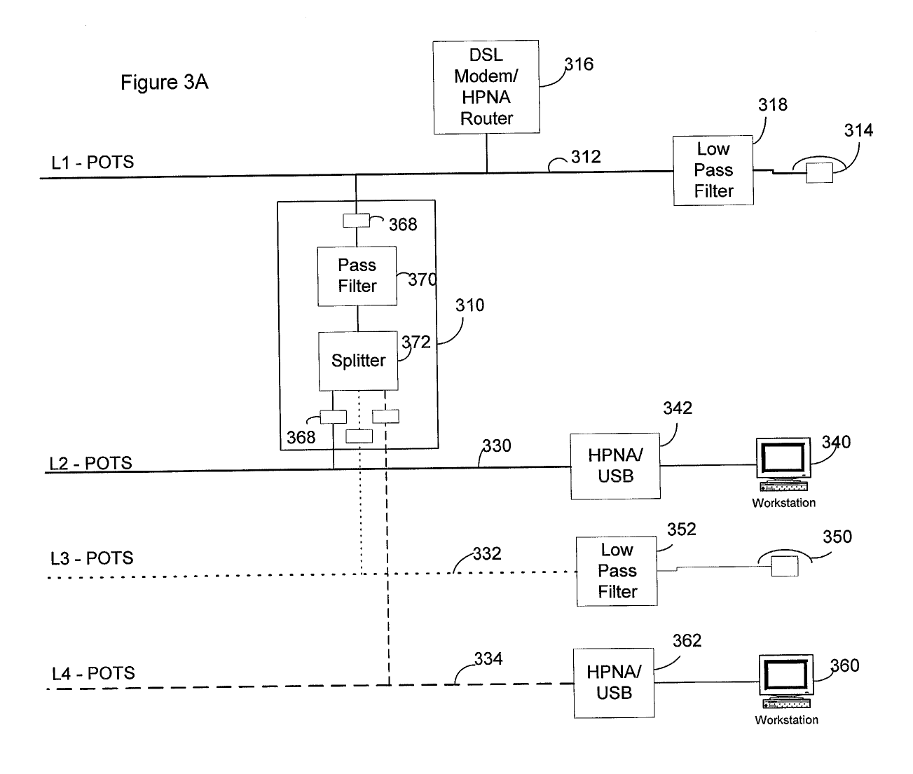

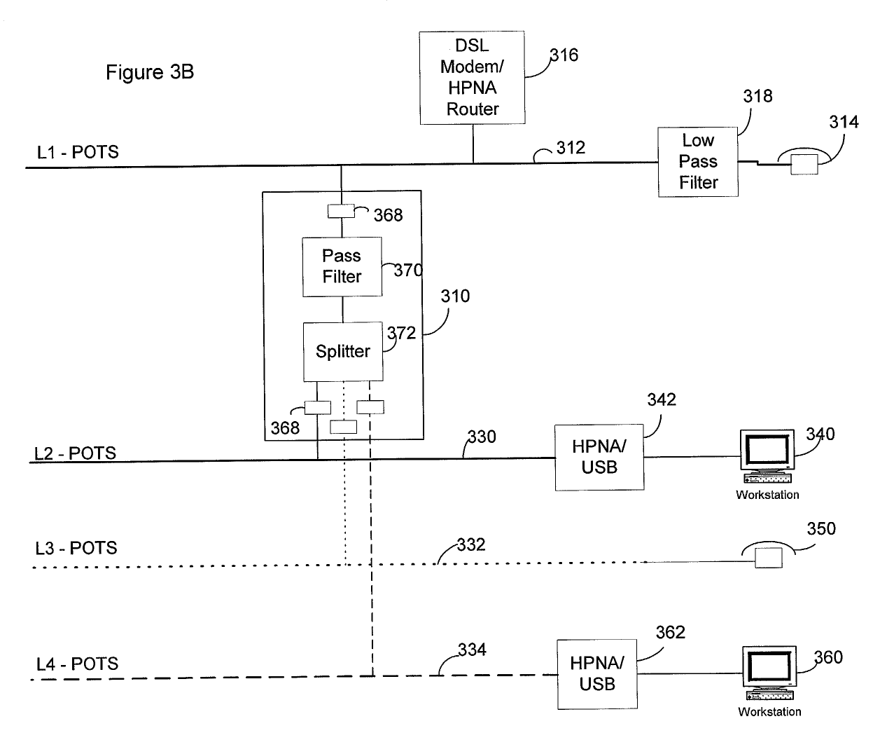

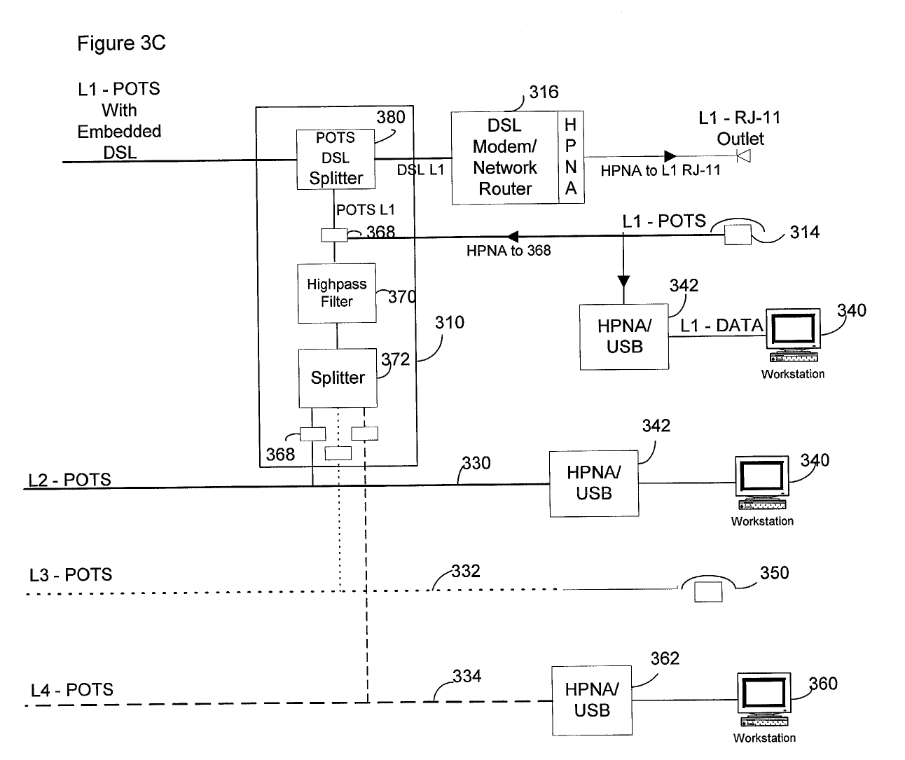

FIG. 3A is a diagram of a bi-directional HPNA bridge 310 in accordance with the invention for bridging HPNA signals across telephone line pairs. A first telephone wire pair 312 is operably connected to an external telephone system and may have telephony signals transmitted thereon directed to telephone 314. First telephone wire pair 312 is also operably connected to broadband device 316, which may be, for example, a DSL modem. It is presumed that broadband device 316 has an HPNA adapter device therein, which may be for example a modem, so as to be accessible to other HPNA enabled devices. Thus, telephone wire pair 312 has telephony signals, xDSL signals, and HPNA signals transmitted simultaneously thereon. Telephone 314 cannot process xDSL and HPNA signals, and therefore has low pass filter 318 associated therewith for removing xDSL and HPNA signals while allowing telephony signals to pass through.

A second telephone wire pair 330, third telephone wire pair 332, and fourth telephone wire pair 334 are also located in the same home or office. Computer 340 is communicatively coupled to second telephone wire pair 330 via USB-to-HPNA adapter 342, which provides for computer 340 to communicate with other HPNA devices similarly connected to telephone wire pair 330. Telephone 350 is communicatively coupled to third telephone wire pair 332 through low pass filter 352. Finally, computer 360 is communicatively coupled to fourth telephone wire pair 334 via USB-to-HPNA adapter 362.

HPNA bridge 310 allows HPNA devices connected to telephone line 312 to access, and be accessed by HPNA devices on telephone wire pairs 330, 332, and 334. Generally, HPNA bridge 310 comprises terminals 368 for connecting to telephone wire pairs, filter 370, and splitter 372. Filter 370 operates to allow HPNA signals to pass through while blocking non-HPNA signals such as telephony signals. According to an aspect of the invention, filter 370 may be a high pass filter that allows signals above a particular frequency to pass through while blocking all frequency signals falling below the particular frequency. For example, filter 370 may allow all signals above 25 KHz, which includes both xDSL and HPNA signals, to pass through while blocking all signals, such as telephony signals, that fall below 25 KHz. According to an alternative embodiment, which is depicted in FIG. 3B, filter 370 may be a band pass filter that allows only frequencies within a desired range to pass. For example, filter 370 may allow only signals between 10 MHz and 15 MHz to pass, which includes only HPNA signals. Accordingly, and as is shown in FIG. 3B, when filter 370 is a band pass filter that filters both regular telephony and xDSL signals, telephone 350 does not require a filter device as in FIG. 3A. According to the embodiment of either FIGS. 3A or 3B, filter 370 allows HPNA signals to pass while blocking telephony signals.

Splitter 372 operates to electrically divide the filtered signal from filter 370 between telephone wire pairs 330, 332, and 334. Thus, HPNA devices connected to telephone line 312 may be accessed by devices such as computers 340 and 360 that are connected to telephone wire pairs 330, 332, and 334. Similarly, HPNA devices connected to telephone wire pairs 330, 332, and 334 may access HPNA devices connected to telephone wire pair 312. For example, computer 340 connected to telephone wire pair 330 can access broadband device 316 connected to telephone wire pair 312.

Splitter 372 may be a passive device that does not add power to the signal from filter 370 but rather relies on the power of the original signal to generate signals on the additional telephone lines. Thus, the HPNA signals transmitted across bridge 310 onto telephone lines 330, 332, and 334 may be attenuated as compared to the original signal, but are sufficiently strong to be operable.

FIG. 3C is diagram depicting an HPNA bridge 310 operable for installation in a telephone system network interface device (NID), i.e. the location where the private telephone wire pairs from a house or office interconnect with the public telephone system wires. HPNA bridge 310 is similar to that shown above in FIG. 3A, but further comprises POTS/DSL splitter 380, which operates to split regular telephony and xDSL signals. The xDSL signal is carried on a separate pair of wiring to the modem in broadband device 316 while the telephony signals are terminated in the NID. Because the xDSL signal is blocked in the POTS/DSL splitter, filter 370 only passes the HPNA signal, which eliminates the need for filters 318 and 352.

Generally, HPNA bridge 310 comprises standard off the shelf electronics components such as, for example, resistors, inductors, and capacitors, that are arranged to provide the filtering and splitting capabilities described above. The electronics components may be soldered together and may be arranged on a printed circuit board with terminals thereon for interconnection between the input and outputs of bridge 310 and the telephone wire pairs that are to be bridged. Furthermore, because HPNA bridge 310 may be a passive device that relies upon power of the original signals for creation of the split signals, the HPNA bridge can be installed at a location without close accessibility to an independent power source. Indeed, an HPNA bridge in accordance with the invention may be physically located anywhere that access may be had to the telephone wire pairs that are to be bridged. For example, HPNA bridge 310 may be located in a telephone system network interface device (NID). The HPNA bridge may be installed on the telephone company side of the NID so as to insure correct installation by trained personnel and to protect from tampering. Of course, the HPNA bridge could also be installed on the customer side of the NID as well. According to another embodiment, the HPNA bridge might be placed inside a device such as broadband device 326. Also, the HPNA bridge might be formed in a faceplate for a telephone outlet. According to another aspect of the invention, the bridge might be implemented using software operating on a processor.

Thus, an HPNA bridge for interconnecting HPNA devices communicating on separate telephone wire pairs has been provided. An HPNA bridge in accordance with the invention can be installed in a home or office so that regardless of the telephone jack into which an HPNA device is plugged, the device is accessible to other HPNA devices in the home. Thus, an HPNA bridge in accordance with the invention greatly simplifies the home networking process for users who no longer need to concern themselves with which telephone wire pair corresponds to which telephone jack.

While the invention has been described and illustrated with reference to specific embodiments, those skilled in the art will recognize that modification and variations may be made without departing from the principles of the invention as described above and set forth in the following claims. For example, while the invention has been described in connection with bridging HPNA signals between four different telephone wire lines, the HPNA bridge may be employed to bridge signals between a smaller plurality as well as a larger plurality of telephone wire pairs. Accordingly, reference should be made to the appended claims as indicating the scope of the invention.

What is claimed is:

1. A bi-directional HPNA bridge, comprising:
at least one input terminal for electrically connecting to a first telephone wire pair;
a filter electrically connected to said at least one input, said filter receiving input signals from said at least one input terminal and blocking non-HPNA signals having a frequency outside of a prescribed frequency range;
a splitter electrically connected to said filter, said splitter receiving a filtered signal from said filter and operable to transmit said filtered signal onto at least a second telephone wire pair.

2. The HPNA bridge of claim 1, wherein said splitter divides said filtered signal into at least two signals representative of the filtered signal.

3. The HPNA bridge of claim 1, wherein said prescribed frequency range is between about 10 MHz and 15 MHz.

4. The HPNA bridge of claim 1 wherein said prescribed frequency range is between about 25 KHz and 15 MHz.

5. The HPNA bridge of claim 1, wherein said prescribed frequency range is about 10 MHz and higher.

6. The HPNA bridge of claim 1, wherein said prescribed frequency range is about 25 KHz and higher.

7. The HPNA bridge of claim 1, further comprising an xDSL/POTS splitter electrically connected between said terminal and said filter for blocking XDSL signals.

8. An HPNA network, comprising
a first telephone wire pair having an HPNA adapted device connected thereto;
a second telephone wire pair having an HPNA adapted device connected thereto;
an HPNA bridge, said HPNA bridge electrically connected to said first telephone wire pair and said second telephone wire pair, wherein said HPNA bridge receives signals from said first telephone wire pair, removes non-HPNA signals outside a frequency range from said signals, and transmits a filtered signal to said second telephone wire pair.

9. The HPNA bridge of claim 8, wherein said frequency range is between about 10 MHz and 15 MHz.

10. The HPNA bridge of claim 8, wherein said prescribed frequency range is between about 25 KHz and 15 MHz.

11. The HPNA bridge of claim 8, wherein said prescribed frequency range is about 10 MHz and higher.

12. The HPNA bridge of claim 8, wherein said prescribed frequency range is about 25 KHz and higher.

13. An HPNA bridge, comprising:
an xDSL/POTS splitter electrically connected to a first telephone wire pair for removing xDSL signals;
a filter electrically connected to said xDSL/POTS splitter, said filter receiving input signals from said xDSL/POTS splitter and blocking non-HPNA signals having a frequency outside of a prescribed frequency range; and
a second splitter electrically connected to said filter, said second splitter receiving a filtered signal from said filter and operable to transmit said filtered signal onto at least a second telephone wire pair.

14. The HPNA bridge of claim 13, wherein said prescribed frequency range is between about 10 MHz and 15 MHz.

15. The HPNA bridge of claim 13, wherein said prescribed frequency range is between about 25 KHz and 15 MHz.

16. The HPNA bridge of claim 13, wherein said prescribed frequency range is about 10 MHz and higher.

17. The HPNA bridge of claim 13, wherein said prescribed frequency range is about 25 KHz and higher.

18. A method of transmitting signals in a home telephone network, comprising:
receiving signals propagating on a telephone wire pair, said signals comprising HPNA signals and non-HPNA signals;
removing non-HPNA signals having a frequency outside of a determined frequency range; and
transmitting a filtered signal to a second telephone wire pair.

19. The method of claim 18, wherein the step of removing non-HPNA signals having a frequency outside of a determined frequency range comprises removing frequency signals outside the range between about 10 MHz and 15 MHz.

20. The method of claim 18, wherein the step of removing non-HPNA signals having a frequency outside of a determined frequency range comprises removing frequency signals outside the range between about 25 KHz and 15 MHz.
